(19) United States
(12) Patent Application Publication
(10) Pub. No.: US 2009/0112901 A1
(43) Pub. Date: Apr. 30, 2009

(54) Software, Systems and Methods for Modifying XML Data Structures

(76) Inventor: Michel Friedman, ShenZhen (CN)

Correspondence Address: POTOMAC PATENT GROUP PLLC, P. O. BOX 270, FREDERICKSBURG, VA, 22404, US

(21) Appl. No.: 12/041,044

(22) Filed: Mar. 3, 2008

Related U.S. Application Data
(60) Provisional application No. 60/905,626, filed on Mar. 8, 2007.

(51) Int. Cl. G06F 17/30

(52) U.S. Cl. 707/101; 707/E17.044

(57) ABSTRACT

Methods, systems and software are described for modifying an Extensible Markup Language (XML) file. Initially, an XML file is provided having at least one data node that contains at least one instruction to modify the XML file. This XML file is parsed to identifying the modification instruction(s) and the XML file is modified in accordance with the at least one instruction to generate a modified XML file.

### RELATED APPLICATION

This application is related to, and claims priority from, U.S. Provisional Patent Application Ser. No. 60/905,626, entitled “Methods and Systems for Transforming and Adding Content to a Template Tree Data Structure Based on a Second Tree Data Structure”, to Michel Friedman, filed on Mar. 8, 2007, the disclosure of which is incorporated here by reference.

### TECHNICAL FIELD

The present invention relates, in general, to information processing, and, more particularly, to software, systems and methods for modifying XML files and generating reports from XML.

### BACKGROUND

Extensible Markup Language (XML) is a leading method of exchanging information between different systems and applications. Many desktop software products also support saving application files as XML and opening XML files inside the application. To exchange information between systems using XML it is usually necessary to convert XML files from the format used by the exporting application to a format used by the importing application.

The primary method of doing such conversion is XSL. XSL is a language for extracting content from an XML file and generating a new XML file using that content. One common approach to building XSL files mimics the structure of the desired output XML file and adds additional XML elements as directives specifying how to extract and merge data from a separate XML file. Creating XSL files using standard XML editors or XSL tools is difficult and requires a programmer with strong knowledge of XSL, of the target XML format and of the XML format of the source file. Many XML formats, such as the ones used by office software, are complex and difficult to work with if the objective is to generate output in those formats.

Modifying those formats to embed XSL commands usually makes it impossible to open the files in the original tools. This means that if one wishes to make a small modification in the desired output file (for example, to generate a Microsoft Word document with particular data in Red instead of Blue) one must either manually modify the XML which describes the format of the output document, a difficult and error prone task even for an expert, or go back to the original template without any XSL directives, make the desired changes in the original tool (i.e., Microsoft Word), save the file, and then add all the XSL commands back in the correct places. This latter process is also difficult and error prone.

Accordingly, a need exists for ways to easily create XSL files based on existing XML files using instructions that are seen by other programs as user data and do not interfere with opening and modifying the file in the software tool that produced the original file.

### SUMMARY

According to an exemplary embodiment, a computer-readable medium contains instructions which, when read by a processor, performs steps for modifying an Extensible Markup Language (XML) file including: identifying, within an XML file having at least one data node that contains at least one instruction to modify the XML file, the at least one instruction, parsing the at least one instruction, and modifying the XML file in accordance with the at least one instruction to generate a modified XML file.

According to another exemplary embodiment, a method for modifying an Extensible Markup Language (XML) file having at least one data or comment node that contains at least one instruction to modify the XML file includes: identifying, within the XML file, the at least one instruction, parsing the at least one instruction, and modifying the XML file in accordance with the at least one instruction to generate a modified XML file.

According to another exemplary embodiment, a system for modifying an Extensible Markup Language (XML) file includes a data store for storing an XML file having at least one data node that contains at least one instruction to modify the XML file, and a processor for identifying and parsing the at least one instruction, and then for modifying the XML file in accordance with the at least one instruction to generate a modified XML file.

According to still another exemplary embodiment, a computer-readable medium contains instructions which, when read by a processor, performs steps for modifying a source data structure including identifying, within a source data structure having at least one data node that contains at least one instruction to modify the source data structure, the at least one instruction, parsing the at least one instruction, and modifying the source data structure in accordance with the at least one instruction to generate a modified source data structure.

### BRIEF DESCRIPTION OF THE DRAWINGS

The accompanying drawings illustrate exemplary embodiments, wherein:

FIG. 1 depicts a process diagram for modifying a source XML file and merging the modified XML file with data according to exemplary embodiments;

FIG. 2 illustrates a system for modifying a source data structure according to exemplary embodiments;

FIG. 3 illustrates an exemplary data file which can be used in conjunction with exemplary embodiments;

FIG. 4 shows an exemplary portion of an XML document associated with an exemplary embodiment;

FIG. 5 is a Word document containing processing instructions which can be saved as an XML file and then processed by an exemplary embodiment; and

FIG. 6 is a flow chart illustrating a method for modifying an XML file or document according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

According to exemplary embodiments, a piece of conventional office software such as Microsoft Office, Open Office, various HTML authoring tools, or other information presentation tools that can save files in XML format, is used to lay out a report. Then one or more instructions are added to the report using that same, conventional office software's user interface so that these modification instruction(s) will be included in the XML file that is saved from that software. These modification instruction(s) will convert the saved source XML File into a processed XML File (e.g., an XSL file) that can convert an XML data file into a report that can be opened by that office software. In this manner, an end-user who is familiar with creating basic word processing documents can also design reports and/or modify the format and layout of existing reports, thereby eliminating most of the need for highly skilled software developers to modify and customize reports to match desired layouts or to make changes to data presentation.

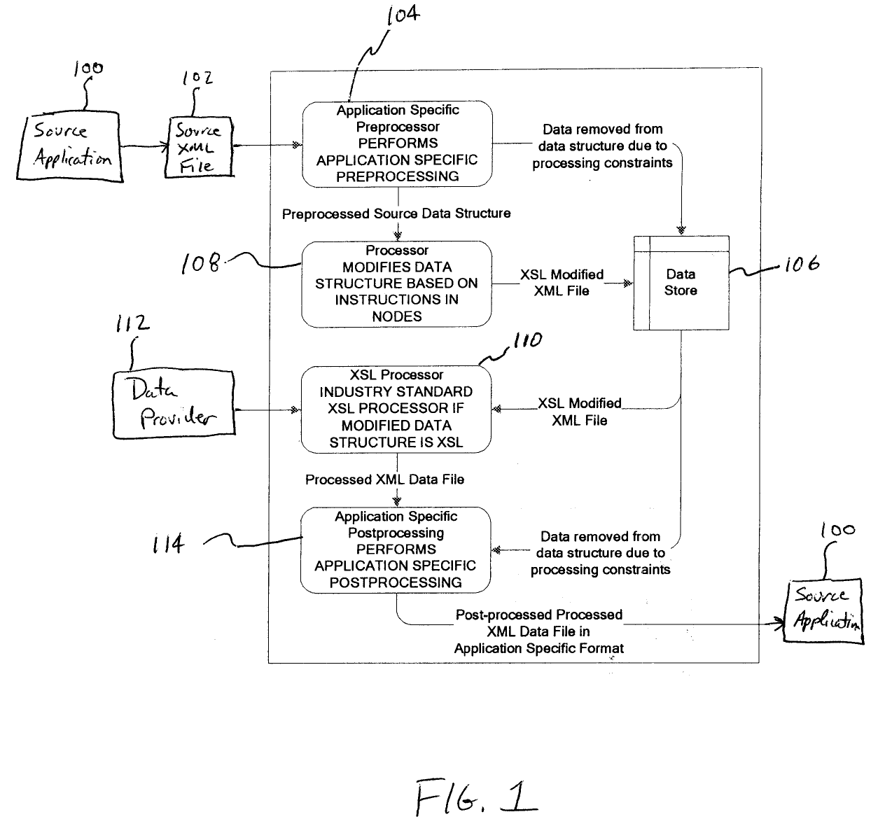

An exemplary embodiment for modifying an XML data structure according to the present invention is illustrated in FIG. 1. Therein, a source application 100, e.g., Microsoft Office, Open Office, an HTML authoring tool or another information presentation tool, is used to generate a source XML file 102. The source XML file 102 contains one or more instructions which have been added thereto that provide information regarding how the source XML file 102 is to be modified for a particular implementation, e.g., to generate a report with certain variations relative to the original template. The source XML file 102 is input to an application specific preprocessor function 104. Application specific preprocessor function 104 operates to regularize the source XML file before considering the embedded modification instruction(s), e.g., to remove elements from the source XML file that cannot be processed by the XSL engine used in a particular implementation or to convert a non-XML file to XML. Any modifications which are made to the source XML file 102 by the application specific preprocessor 104 are passed on to data store 106 for storage and subsequent recovery as will be described below. Once the source XML file 102 has been preprocessed, it is then passed on to the main processing function 108 which parses the source XML file to identify the one or more instructions embedded therein which inform the main processing function 108 of the manner in which the source XML file 102 is to be modified. The main processing function 108 then makes the instructed modification(s) and passes the resulting modified XML file (e.g., an XSL file) to the data store 106, wherein it is saved until needed for operation, e.g., report generation. Although the source data file 102 is, in this exemplary embodiment, an XML file 102, it will be appreciated by those skilled in the art that other implementations of the present invention may use other types of source data structures. For example, for Open Office, the saved file which operates as the source data file 102 is a ZIP file from which an XML file can be extracted.

When an operation is to be performed using the modified XML file, it is then retrieved from the data store 106 by, in this exemplary embodiment, an XSL processing function 110. The XSL processing function 110 uses the XSL file to transform an XML file provided by a data provider 112 to generate a processed XML data file which is structured similarly to the XML file generated by the application specific pre-processor 106 but which contains the data from the XML data file. The processed XML data file is input to an application specific post processing function 114 which essentially reverses the process performed by the application specific preprocessing function 104, e.g., to replace data which was removed by the preprocessing function 104 or converting the XML back to a non-XML format. To accomplish this, the application specific post processing function retrieves information from the data store 106 indicating what, if any, modifications to the source XML file 102 were made by the application specific preprocessing function 104. The result, a post-processed XML data file in a format specific to the source application, is then output to the same source application 100 for, e.g., viewing as a report.

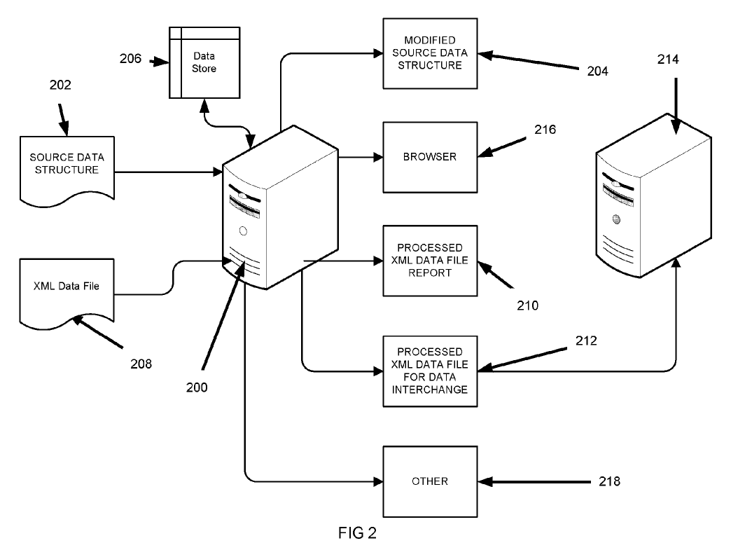

Having described an exemplary embodiment of the present invention from a process point of view, FIG. 2 illustrates an exemplary embodiment from a system point of view. Therein, a processing server, personal computer or other processing device 200 receives, as one input, a source data structure 202 (e.g., a source XML file) generated by, e.g., a user using an office software application. After pre-processing (if any) is performed, the source data structure 202 is modified by processor 200, as described above, based upon one or more modification instructions embedded in the source data structure to generate a modified source data structure 204. The modified source data structure 204 can be stored in data store 206 which can be implemented as memory internal to processing device 200 (removable or fixed media) or external memory, e.g., the modified source data structure can be transmitted over a network such as the Internet to a remote storage location (not shown).

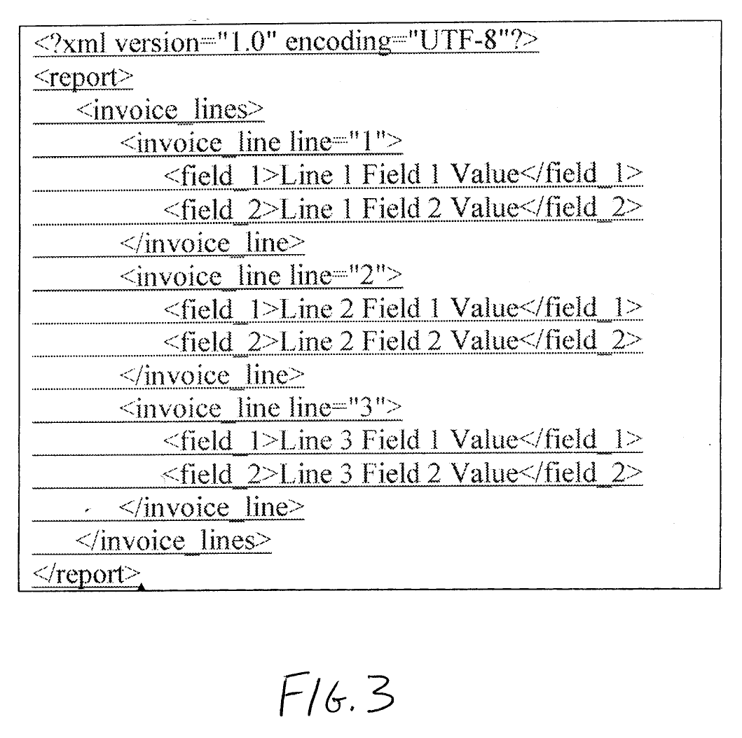

Subsequently, an operation can be performed using the modified source data structure 204, e.g., a report can be generated using the data structure 204. To fill in the report, data is provided to the processing device 200, in this example from an XML data file 208 to fill in any variables present in the modified source data structure 204. A purely illustrative example of such an XML data file 208 is provided as FIG. 3. After post-processing (if any) is performed, the processing device 200 can then output, for example, a processed XML data file report 210 via the source application (not shown in FIG. 2). Note that although this exemplary embodiment illustrates the same processing device 200 generating both the modified source data structure 204 and the processed XML data file report 210, according to other exemplary embodiments two different processing devices 200 can be used to generate the modified data structure 204 and the processed XML data file or report, respectively, as long as the two processing devices 200 both have access to the data store 206 in which the modified data structure 204 is stored and from which it is subsequently retrieved as described above. Additionally, it will be noted that the XML data file 208 can also be stored in data store 206 and retrieved therefrom. In general, the formatting and presentation specifics of the report 210 are determined by the source data structure 202, while the data content of the report 210 is determined by the data source 208.

As alternatives to, or in addition to, outputting a report 210, processing device 200 can also generate other outputs as a result of processing in accordance with these exemplary embodiments. For example, this transformation engine can also be used to implement an XML export system for data interchange with other systems. In such an embodiment, processing device 200 again takes a source data structure 202 created using XML editing software and transforms this file into a modified source data structure 204 (e.g., an XSL modified XML file 204) which is then saved in the data store 206. The processing device 200 then takes an XML data file 208, e.g., from the data store 206 and uses the modified source data structure 204 to transform the XML data file 208 into a processed XML data file for data interchange 212. The processing device 200 then sends this file 212 as a part of a message to an external application 214 which may be operating on a different processing device or server. In this data interchange exemplary embodiment, XML editing tools are used to modify a template message by inserting instructions to convert the template (e.g., the source XML file 102) to XSL in text or comment nodes. This provides a convenient mechanism for developers to create XSL files that map data XML files to standard data interchange messages.

This latter exemplary embodiment can be used, for example, to provide a file 212 as an electronic data interchange (EDI) message. For example, processing device 200 could be a supplier's enterprise resource planning (ERP) system, and processing device 214 could be a customer's ERP system, and the file 212 could be an Advance Shipment Notice (ASN) listing the boxes and their contents being shipped by the supplier to the customer. Alternatively, processing devices 200 and 214 could be medical record systems in two separate hospitals and the file 212 could be a patient's medical records. As yet another alternative, processing device 200 could be an insurance broker's system, processing device 214 could be an insurance company's system, and the file 212 could be an insurance application. Those skilled in the art will appreciate that numerous other applications for EDI embodiments of the present invention can be implemented.

In still another application, the processing device 200 may take an XML data file 208, e.g., from the data store 206 and use the modified source data structure 204 to transform the XML data file 208 into a processed XML data file in XHTML format for presentation in an Internet Web Browser 216. Other software or hardware mechanisms 218 may also receive and process modified source data structures according to these exemplary embodiments to accomplish other objectives, including a utility sending real time electricity pricing information to consumer devices such as clothes dryers (to turn them on at the cheapest time each night) or thermostats (to reduce heating/cooling during peak usage), a smart home management system sending instructions to various home appliances, industrial machinery sending information about production and exception conditions, etc.

Having provided some illustrative overall exemplary embodiments, the discussion will now turn to more detailed examples of various aspects described above to further illustrate the present invention. It will be appreciated by those skilled in the art that these examples are intended to be in all respects purely illustrative, rather than limiting, of the present invention. Initially, it will be noted that the exemplary process described in FIG. 1 has four primary processing stages: (1) preprocessing of a source document, (2) processing of a source document, (3) retrieval and merging of a source document with data and (4) post processing of the resulting data structure. Some examples of each of these processing stages will now be provided in turn. These examples are provided using exemplary implementations in an Oracle database, however it will be appreciated by those skilled in the art that these same techniques can be implemented in any language that contains, for example, XML DOM and XPath libraries or which is powerful enough to allow the implementation of those libraries. This includes, for example, .NET, Java, all modern relational and object oriented databases, C, Pascal, and almost all “3GL”s, assembly language, and machine language.

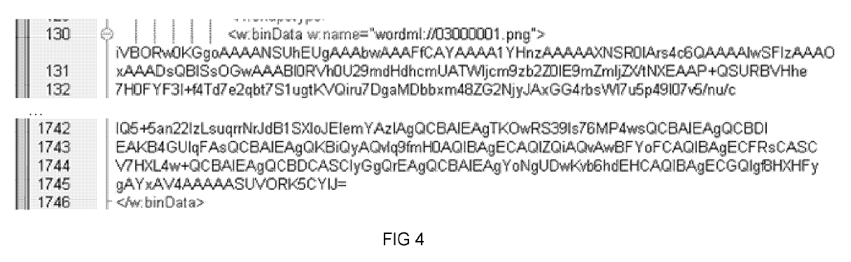

The application specific preprocessor function 104 performs any operations needed to generate a preprocessed XML source data file that can be handled using, in this example, Oracle's native XML support. Two examples are provided here for preprocessing in conjunction with Microsoft Office and Open Office, however it will be appreciated that there is no limitation on the formats that can be used. For example, Microsoft Office stores embedded images and objects as long UUEncoded text data elements in XML, an example of which is illustrated as FIG. 4. Since Oracle only supports nodes of up to 64K in size, the application specific preprocessor function 104 replaces these embedded images and objects with a hash and stores the original data in data store 106 so that it can be reconstituted during application specific postprocessing. Microsoft Office also inserts tags that indicate words or phrases that have not passed spell and grammar checking, which tags may also optionally be removed by the application specific preprocessor 104, e.g., using an XSLT transformation to remove them.

For different source applications which may be used to create the source XML file 102, it is anticipated that the application specific preprocessing function 104 will perform different functions to prepare the source XML file 102 for subsequent modification. Consider, for example, the Open Office application as compared to Microsoft Office described above. Open Office data formats are all JAR files, i.e., they employ ZIP compression, which contain multiple files and a directory structure. Suppose that a source XML data file 102 is generated using Open Office as the source application 100 and is called content.xml within the resulting JAR file. In this case, the application specific preprocessor function 104 will extract the content.xml file as the XML source file 102 and store the JAR in data store 106 so that it can be reconstituted during the application specific postprocessing phase 114 described above.

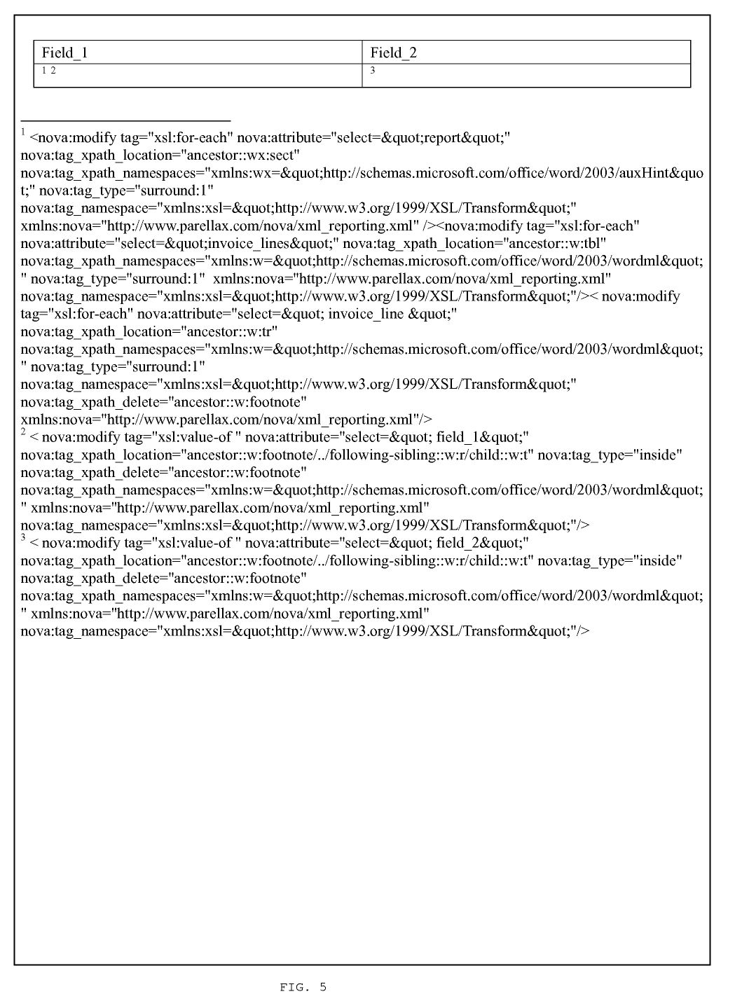

Having provided some examples of the application specific preprocessor 104, the focus now turns to some detailed examples of the main processing function 108 which modifies the preprocessed source data file passed on from the preprocessor 104. For example, as mentioned above, an XML processing function 108 takes a preprocessed XML file that was originally created by an end user tool such as Microsoft Office or Open Office, analyzes the file, finds directives (modification instructions) in text or comment (CDATA) nodes, and uses those directives to add additional tags that will be used by the XSL processing function 110 to merge the incoming data with the modified XML file. Consider, for example, the Microsoft Word document illustrated in FIG. 5. This document can be saved as an XML document (see Appendix A—XML code example), below.

According to an exemplary embodiment, the modification instructions to be used to modify the XML document corresponding to the Word document of FIG. 5 are stored in text nodes in the corresponding XML document. For example, the first modification instruction

“<nova:modify tag=″xsl:for-each″
nova:attribute=″select=&quot;report&quot;″
nova:tag_xpath_location=″ancestor::wx:sect″
nova:tag_xpath_namespaces=″xmlns:wx=&quot;http://schemas.microsof
t.com/office/word/2003/auxHint&quot;″ nova:tag_type=″surround:1″
nova:tag_namespace=″xmlns:xsl=&quot;http://www.w3.org/1999/XSL/Tr
ansform&quot;″
xmlns:nova=″http://www.parellax.com/nova/xml_reporting.xml″ />”
is stored as:

<w:t>&lt;nova:modify tag=″xsl:for-each″

nova:attribute=″select=&amp;quot;report&amp;quot;″
nova:tag_xpath_location=″ancestor::wx:sect″
nova:tag_xpath_namespaces=″xmlns:wx=&amp;quot;http://schemas.micr
osoft.com/office/word/2003/auxHint&amp;quot;″
nova:tag_type=″surround:1″
nova:tag_namespace=″xmlns:xsl=&amp;quot;http://www.w3.org/1999/XS
L/Transform&amp;quot;″
xmlns:nova=″http://www.parellax.com/nova/xml reporting.xml″ /&gt;

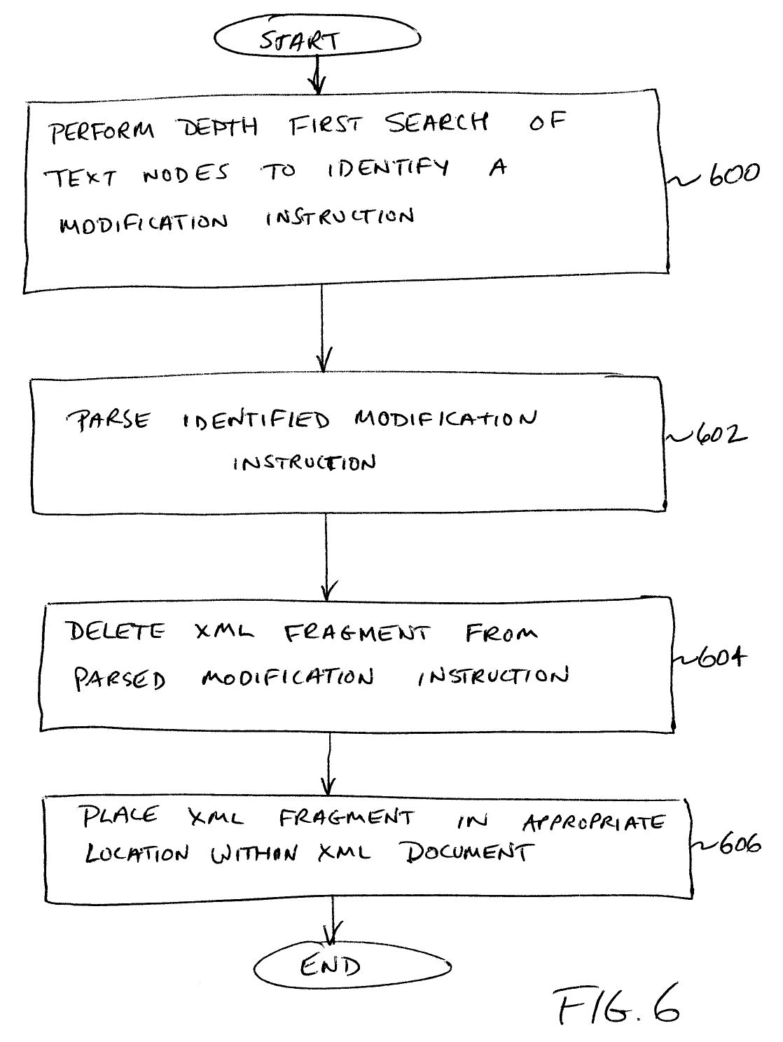

Modification instructions such as that depicted above can be readily found within the source XML file 102 by the XML processing function 110, e.g., using Oracle's regular expression functions and extracting the actual content after reconstituting symbols such as ‘<’ and ‘>’ from escaped values such as ‘&lt;’ and ‘&gt;’. An exemplary, general process for identifying such modification instructions, and then processing them to modify the XML source document is illustrated in the flowchart of FIG. 6. First, a depth first search of text nodes within the preprocessed XML file is performed to look for text nodes that contain well formed XML fragments with modification instructions in, optionally, the desired namespace at step 600. For example, the tag_xpath_namespace attribute can contain a list of prefixes and namespace URIs. If the number of strings in the attribute value is odd then the first string is a default namespace URI. Otherwise, if the number of strings in the attribute is even, then the first string is the first prefix and will be followed by its namespace URI. These namespaces are the namespace context for the tag_xpath_location string. The optional use of a namespace as a filter for identifying modification instructions prevents conflicts between arbitrary tag names associated with modification instructions and other uses of the same name by an application. In this exemplary embodiment, a depth first order is used in which to apply transformations although, more generally, other predetermined orders in which to process the transformations could be used so long as they are known a priori to provide predictable results and promote tag referencing, e.g., if transformations are applied in a known order then a modification instruction that is created by one transformation can be referenced in a later transformation.

Next, for each of those text nodes identified by step 600, the modification instruction is parsed in the desired namespace at step 602. Based on the attributes and information contained in the parsed modification instruction, the XML fragment portion thereof is deleted from the text node at step 604 and placed in the appropriate location within the XML document at step 606. This sequence of exemplary steps creates the desired of modifications to the source XML document 102 based on one or more modification instructions embedded therein. As described above with respect to FIG. 1, the resulting, modified XML file can then be stored in data store 106. As noted above, the modification instructions can include tag attributes and tag type values which are used by the processing function 108 to determine how/where to make the requested modification within the XML document. Some examples of tag attributes and tag types which can be used according to these exemplary embodiments are provided below in Tables 1 and 2.

TABLE 1

| Tag | Meaning |
|---|---|
| tag_xpath_location | XPath search string that should be evaluated in the context of the text |
| | node and used to determine the location to place the new element in the |
| | XML document. |
| tag_xpath_namespace | Namespace string defining the namespace context in which to evaluate the |
| | tag_xpath_location XPath string |
| tag_type | Instruction telling where to place the element relative to the node selected |
| | by the tag_xpath_location string. |
| | The tag_type attribute contains a Type followed by an optional “:” and a |
| | number - “tag_type:n”:. For example, “surround:2”. If the “:” and n are |
| | not there then the value of n defaults to 1. |
| delete_xpath | XPath search string that specifies a list of nodes to delete after the XML |
| | fragment is moved. |
| | This can be used to make formatting of template documents easier by |
| | placing a tag in a comment or a footnote and then deleting the comment or |
| | footnote so it will not show up in the final report. |

TABLE 2

| Tag_Type Values | Meaning |
|---|---|
| surround | Place n sibling nodes starting with the selected node inside the element. |
| | Place the element under the selected node's parent. |
| inside | Place the node inside the selected node. Place all of the selected node's |
| | element and text children under the node. Ignore n. |
| replace | Replaces the selected node. This will usually be used to replace a Text |
| | node. |
| set_attribute_value | Replaces the value of the selected attribute. The value will be prefixed |
| | with a hash value selected by the application to make it easy to find and to |
| | make sure that it can be distinguished from any similar values that are not |
| | created by the preprocessor. |
| xpath: [XPath | Provides an XPath expression to specify a list of nodes that should be |
| Expression] | taken from other locations in the document and made children of the |
| | newly inserted node. |

To better understand the exemplary method of FIG. 6 for modifying an XML file or document according to these exemplary embodiments consider its application to an exemplary XML document, e.g., that shown in the above-incorporated by reference provisional patent application. For example, when the processing function 108 reaches and identifies the first modification instruction provided therein, i.e., &lt;nova:modify tag=“xsl:for-each” nova:attribute=“select=&amp;quot;report&amp;quot;” nova:tag_xpath_location=“ancestor::wx:sect” nova:tag_xpath_namespaces=“xmlns:wx=&amp;quot;http://schemas.microsoft.com/office/word/2003/auxHint&amp;quot;” nova:tag_type=“surround:1” nova:tag_namespace=“xmlns:xsl=&amp;quot;http://www.w3.org/1999/XS L/Transform&amp;quot;” xmlns:nova=“http://www.parellax.com/nova/xml_reporting.xml”/&gt; at step 600, it will then parse that modification instruction at step 602 to separate out the tag value, tag type value(s) and XML fragment. Note that the phrase “tag value” as used herein is generic to tag values and tag type values collectively or individually. In this example, the tag value tag_xpath_location string is an XPath string that describes where this modification should be placed within the XML document or file. The XPath string value can be a relative XPath value or an absolute XPath value, in this particular example it is the relative XPath value “ancestor::wx:sect”, which maps to “wx:sect” node that is the nearest ancestor of the modification instruction node of the XML document undergoing modification. The tag_type value in this exemplary modification instruction is “surround: 1”, which describes where to insert the XML modification relative to the target node. In this example, the “surround” value denotes placement around the target node specified by the XPath value, and the value “1” indicates that the modification should only be placed around just that node, not extending to any siblings. See Table 2 for other tag type values according to exemplary embodiments. The modification is inserted as requested and the tag_xpath_namespace, tag_xpath_location, and tag_type attributes are removed from the XML document so that they will not be reapplied a second time, resulting in the modified XML snippet of:

<w:body>

<xsl:for-each select=“report”

xmlns:xsl=“http://www.w3.org/1999/XSL/Transform”>

<wx:sect>

...

</wx:sect>

</xsl:for-each>

</w:body>

, where the bolded XML statement has been added by way of this modification process.

The other modification instructions are processed in a manner similar to that described above. Those XML statements without, according to this exemplary embodiment, a tag_xpath_location attribute will not be modified during this processing. For example, the fragment:

<w:tbl>

<w:tblPr>

<w:tblStyle w:val=“TableGrid”/>
<w:tblW w:w=“0” w:type=“auto”/>
<w:tblLook w:val=“01E0”/>

</w:tblPr>
<w:tblGrid>

<w:gridCol w:w=“5328”/>
<w:gridCol w:w=“5328”/>

</w:tblGrid>
<w:tr wsp:rsidR=“00AA164E”>

<w:tc>

<w:tcPr>
<w:tcW w:w=“5328” w:type=“dxa”/>

</w:tcPr>
<w:p wsp:rsidR=“00AA164E” wsp:rsidRDefault=“0060104C”>

<w:r>

<w:rPr>

<w:rFonts w:hint=“fareast”/>

</w:rPr>
<w:t>Field_1</w:t>

</w:r>

</w:p>

</w:tc>
<w:tc>

<w:tcPr>

<w:tcW w:w=“5328” w:type=“dxa”/>

</w:tcPr>
<w:p wsp:rsidR=“00AA164E” wsp:rsidRDefault=“0060104C”>

<w:r>

<w:rPr>

<w:rFonts w:hint=“fareast”/>

</w:rPr>
<w:t>Field_2</w:t>

</w:r>

</w:p>

</w:tc>

</w:tr>
<w:tr wsp:rsidR=“00AA164E”>

<w:tc>

<w:tcPr>

<w:tcW w:w=“5328” w:type=“dxa”/>

</w:tcPr>
<w:p wsp:rsidR=“00AA164E” wsp:rsidRDefault=“0060104C”>

<w:r>

<w:rPr>

<w:rStyle w:val=“FootnoteReference”/>

</w:rPr>
<w:footnote>

<w:p wsp:rsidR=“00AA164E” wsp:rsidRDefault=“0060104C”>

<w:pPr>

<w:pStyle w:val=“FootnoteText”/>

</w:pPr>
<w:r>

<w:rPr>

<w:rStyle w:val=“FootnoteReference”/>

</w:rPr>
<w:footnoteRef/>

</w:r>
<w:r>

<w:t>&lt;nova:modify tag=“xsl:for-each”

nova:attribute=“select=&amp;quot;report&amp;quot;”

nova:tag_xpath_location=“ancestor::wx:sect”
nova:tag_xpath_namespaces=“xmlns:wx=&amp;quot;http://s

chemas.microsoft.com/office/word/2003/auxHint&amp;quot;”

nova:tag_type=“surround:1”
nova:tag_namespace=“xmlns:xsl=&amp;quot;http://www.w3.

org/1999/XSL/Transform&amp;quot;”

xmlns:nova=“http://www.parellax.com/nova/xml_reporting

.xml”

/&gt;&lt;nova:modify tag=“xsl:for-each”
nova:attribute=“select=&amp;quot;invoice_lines&amp;quo

t;”

nova:tag_xpath_location=“ancestor::w:tbl”
nova:tag_xpath_namespaces=“xmlns:w=&amp;quot;http://sc

hemas.microsoft.com/office/word/2003/wordml&amp;quot;”

nova:tag_type=“surround:1” xmlns:nova=“http://www.pare

llax.com/nova/xml_reporting.xml”

nova:tag_namespace=“xmlns:xsl=&quot;http://www.w3.

org/1999/XSL/Transform&amp;quot;”/&gt;&lt;

nova:modify tag=“xsl:for-each”
nova:attribute=“select=&amp;quot;invoice_line
&amp;quot;” nova:tag_xpath_location=“ancestor::w:tr”
nova:tag_xpath namespaces=“xmlns:w=&amp;quot;http://sc

hemas.microsoft.com/office/word/2003/wordml&amp;quot;”

nova:tag_type=“surround:1”
nova:tag_namespace=“xmlns:xsl=&amp;quot;http://www.w3.

org/1999/XSL/Transform&amp;quot;”

nova:tag_xpath_delete=“ancestor::w:footnote”
xmlns:nova=“http://www.parellax.com/nova/xml_reporting

.xml”/&gt;</w:t>

</w:r>

</w:p>

</w:footnote>

</w:r>
<w:r>

<w:rPr>

<w:rFonts w:hint=“fareast”/>

</w:rPr>
<w:t></w:t>

</w:r>
<w:r>

<w:rPr>

<w:rStyle w:val=“FootnoteReference”/>

</w:rPr>
<w:footnote>

<w:p wsp:rsidR=“00AA164E” wsp:rsidRDefault=“0060104C”>

<w:pPr>

<w:pStyle w:val=“FootnoteText”/>

</w:pPr>
<w:r>

<w:rPr>

<w:rStyle w:val=“FootnoteReference”/>

</w:rPr>
<w:footnoteRef/>

</w:r>
<w:r>

<w:t>&lt;nova:modify tag=“xsl:value-of”

nova:attribute=“select=&amp;quot; field_1&amp;quot;”
nova:tag_xpath_location=“ancestor::w:footnote/../follo

wing-sibling::w:r/child::w:t”

nova:tag_type=“inside”
nova:tag_xpath_delete=“ancestor::w:footnote”
nova:tag_xpath_namespaces=“xmlns:w=&amp;quot;http://sc

hemas.microsoft.com/office/word/2003/wordml&amp;quot;”

xmlns:nova=“http://www.parellax.com/nova/xml_reporting

.xml”

nova:tag_namespace=“xmlns:xsl=&amp;quot;http://www.w3.

org/1999/XSL/Transform&amp;quot;”/&gt;</w:t>

</w:r>

</w:p>

</w:footnote>

</w:r>
<w:r>

<w:rPr>

<w:rFonts w:hint=“fareast”/>

</w:rPr>
<w:t></w:t>

</w:r>

</w:p>

</w:tc>
<w:tc>

<w:tcPr>

<w:tcW w:w=“5328” w:type=“dxa”/>

</w:tcPr>
<w:p wsp:rsidR=“00AA164E” wsp:rsidRDefault=“0060104C”>

<w:r>

<w:rPr>

<w:rStyle w:val=“FootnoteReference”/>

</w:rPr>
<w:footnote>

<w:p wsp:rsidR=“00AA164E” wsp:rsidRDefault=“0060104C”>

<w:pPr>

<w:pStyle w:val=“FootnoteText”/>

</w:pPr>
<w:r>

<w:rPr>

<w:rStyle w:val=“FootnoteReference”/>

</w:rPr>
<w:footnoteRef/>

</w:r>
<w:r>

<w:t>&lt;nova:modify tag=“xsl:value-of”

nova:attribute=“select=&amp;quot; field_2&amp;quot;”
nova:tag_xpath_location=“ancestor::w:footnote/../follo

wing-sibling::w:r/child::w:t”

nova:tag_type=“inside”
nova:tag_xpath_delete=“ancestor::w:footnote”
nova:tag_xpath_namespaces=“xmlns:w=&amp;quot;http://sc

hemas.microsoft.com/office/word/2003/wordml&amp;quot;”

xmlns:nova=“http://www.parellax.com/nova/xml_reporting

.xml”

nova:tag_namespace=“xmlns:xsl=&amp;quot;http://www.w3.

org/1999/XSL/Transform&amp;quot;”/&gt;</w:t>

</w:r>

</w:p>

</w:footnote>

</w:r>
<w:r>

<w:rPr>

<w:rFonts w:hint=“fareast”/>

</w:rPr>
<w:t></w:t>

</w:r>

</w:p>

</w:tc>

</w:tr>>

</w:tbl>

Will be transformed using these exemplary embodiments to become (with the bolded statements reflecting modifications):

<xsl:for-each select=“invoice_lines”

xmlns:xsl=“http://www.w3.org/1999/XSL/Transform”>

<w:tbl>

<w:tblPr>

<w:tblStyle w:val=“a3”/>
<w:tblW w:w=“0” w:type=“auto”/>

<w:tblLook w:val=“01E0”/>

</w:tblPr>
<w:tblGrid>

<w:gridCol w:w=“5328”/>
<w:gridCol w:w=“5328”/>

</w:tblGrid>
<w:tr>

<w:tc>

<w:tcPr>

<w:tcW w:w=“5328” w:type=“dxa”/>

</w:tcPr>
<w:p>

<w:r>

<w:rPr>

<w:rFonts w:hint=“fareast”/>

</w:rPr>
<w:t>Field_1</w:t>

</w:r>

</w:p>

</w:tc>
<w:tc>

<w:tcPr>

<w:tcW w:w=“5328” w:type=“dxa”/>

</w:tcPr>
<w:p>

<w:r>

<w:rPr>

<w:rFonts w:hint=“fareast”/>

</w:rPr>
<w:t>Field_2</w:t>

</w:r>

</w:p>

</w:tc>

</w:tr>
<xsl:for-each select=“invoice_line”

xmlns:xsl=“http://www.w3.org/1999/XSL/Transform”>

<w:tr>

<w:tc>

<w:tcPr>

<w:tcW w:w=“5328” w:type=“dxa”/>

</w:tcPr>
<w:p>

<w:r>

<w:rPr>

<w:rStyle w:val=“a5”/>

</w:rPr>

</w:r>

<w:r>

<w:rPr>

<w:rFonts w:hint=“fareast”/>

</w:rPr>
<w:t/>

</w:r>
<w:r>

<w:rPr>

<w:rStyle w:val=“a5”/>

</w:rPr>

</w:r>
<w:r>

<w:rPr>

<w:rFonts w:hint=“fareast”/>

</w:rPr>
<w:t>

<xsl:value-of select=“field_1”

xmlns:xsl=“http://www.w3.org/1999/XSL/Trans

form”/>

</w:t>

</w:r>

</w:p>

</w:tc>
<w:tc>

<w:tcPr>

<w:tcW w:w=“5328” w:type=“dxa”/>

</w:tcPr>
<w:p>

<w:r>

<w:rPr>

<w:rStyle w:val=“a5”/>

</w:rPr>

</w:r>
<w:r>

<w:rPr>

<w:rFonts w:hint=“fareast”/>

</w:rPr>
<w:t>

<xsl:value-of select=“field_2”

xmlns:xsl=“http://www.w3.org/1999/XSL/Trans

form”/>

</w:t>

</w:r>

</w:p>

</w:tc>

</w:tr>

</xsl:for-each>

</w:tbl>

</xsl:for-each>

Once all of the indicated modifications are performed to the XML source document or file, the resulting, modified XML document or file can be stored in the data store 106, 206 as described above for subsequent usage in, e.g., merging with XML data or the like. Some exemplary details regarding how this latter phase of the process can be performed are provided above with respect to FIGS. 1 and 2, and more exemplary details can be found in the above-incorporated by reference provisional patent application.

In the exemplary embodiments described above, locations for modifying a source XML file 101 are specified using XPath. Alternatively, instead of an XML file, it is contemplated that the source data structure may be any data structure that can be modeled as a network of nodes together with a language for specifying which nodes to modify in either absolute terms or relative to a node containing a modification instruction. In fact, the present invention is independent of the exemplary data structures described herein, as long as the data structure of interest can, for example, be represented as a network. The present invention is also independent of the physical implementation of data store 206. Data store 206 may be directly connected to processing server 200 and/or attached by a network, and may be implemented as single computer system or as a distributed database spanning several computer systems.

By using conventional office software to create the initial XML template, exemplary embodiments leverage all of the functionality and features of commercial office software to implement a user interface. This provides end-users with the capability to create and modify a report template. This transformation engine can be used to implement a reporting module in a matter of days by one developer. This includes incorporating the report design system of the present invention into an existing database, information management system, or the like as well as designing and creating the reports themselves. The present invention eliminates the expense and frustration associated with iterative report development processes. Because the report can be designed in familiar office software such as Microsoft Word such that anyone familiar with word processing can design their own reports. Because users are designing reports for themselves, they are more likely to design a report including the features and content that they desire, and do so quickly. The present invention can use industry standards. Report design can be via Microsoft Word, for example, and message design can be via any XML editor and the invention can be implemented in software written in Oracle PL/SQL. Modification instructions are written in XML and use XPath, a standard for identifying extensible markup language (xml) elements. According to some exemplary embodiments, the present invention exports messages in XML or publishes reports in a variety of industry standard formats including hypertext markup language (HTML), Microsoft Office XML, and Open Office XML. HTML reports can be created with or without cascading style sheets. The present invention easily integrates into existing enterprise systems, e.g., as a single API call that passes two streams in and receives the message or report back in a third stream.

From the foregoing, it will be appreciated that these exemplary embodiments apply to any tree data structure that includes a language for defining paths (similar to XPath) for defining the location of a node relative to a reference node. Exemplary embodiments include, among other things a system and method for taking data within an XML document (e.g., text you type into an MS Word document) and turning it into XML nodes in the document (this is used to prepare the template from a document created in an end user tool like MS Word, Excel, etc.). Other exemplary embodiments further include a system and method for taking data within an XML document (e.g., text you type into an MS Word document) and turning it into XML nodes in the document (this is used to prepare the template from a document created in an end user tool like MS Word, Excel, etc.) and merging the Report Data with the XML Template generated in the first step.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The above-described exemplary embodiments are intended to be illustrative in all respects, rather than restrictive, of the present invention. Thus the present invention is capable of many variations in detailed implementation that can be derived from the description contained herein by a person skilled in the art. Various alternatives are also contemplated by exemplary embodiments of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A computer-readable medium which contains instructions which, when read by a processor, performs steps for modifying an Extensible Markup Language (XML) file comprising:
identifying, within an XML file having at least one data node that contains at least one instruction to modify said XML file, said at least one instruction;
parsing said at least one instruction; and
modifying said XML file in accordance with said at least one instruction to generate a modified XML file.

2. The computer-readable medium of claim 2, wherein said step of parsing further comprises:
parsing a tag value and an XML fragment from said at least one instruction.

3. The computer-readable medium of claim 2, wherein said step of modifying further comprises:
placing said XML fragment at a location within said XML file, which location is determined based upon said tag value.

4. The computer-readable medium of claim 3, wherein said tag value includes a surround attribute and a number n and wherein said modifying step further comprises:
placing said XML fragment around n sibling nodes, starting with a node at the location specified by said tag value.

5. The computer-readable medium of claim 3, wherein said tag value includes an inside value and wherein said step of modifying further comprises:
placing the XML fragment inside a node specified by said tag value.

6. The computer-readable medium of claim 3, wherein said tag value includes a replace value and wherein said step of modifying further comprises:
replacing a node specified by said tag value with said XML fragment.

7. The computer-readable medium of claim 3, wherein said tag value includes a set attribute value and wherein said step of modifying further comprises:
replacing a value of a selected attribute specified by said tag value with said XML fragment.

8. The computer-readable medium of claim 1, further comprising the step of:
creating said XML file by exporting information from another software tool.

9. The computer-readable medium of claim 1, further comprising:
wherein said at least one instruction to modify said XML file is embedded as user data using a user interface of the software tool.

10. The computer-readable medium of claim 1, wherein the at least one instruction for modifying the XML file is disposed in one of a text node and a comment node.

11. The computer-readable medium of claim 1, where the at least one instruction for modifying the XML File uses XPath to specify at least one location at which to make modifications.

12. The computer-readable medium of claim 1, wherein the XML File is an HTML file and said at least one instruction to modify the XML File are stored as text or comments in the HTML file.

13. The computer-readable medium of claim 1, wherein the XML file is saved from one of Microsoft Office and Open Office and the at least one instruction to modify the XML File is created using a respective user interface provided in said one of one of Microsoft Office and Open Office.

14. The computer-readable medium of claim 1, wherein the modified XML File is an XSL file.

15. The computer-readable medium of claim 12, further comprising:
applying the XSL file to said XML file to create a processed XML data file.

16. The computer-readable medium of claim 15, wherein the processed XML data file is a report and wherein the report can be opened in a software tool that was used to generate the XML file.

17. The computer-readable medium of claim 15, wherein the processed XML data file is used for data interchange.

18. The computer-readable medium of claim 1, further comprising:
modifying the XML file by an application specific pre-processor before generating the modified XML file.

19. The computer-readable medium of claim 18, wherein said application specific preprocessor extracts the XML file from an archive file containing multiple files.

20. The computer-readable medium of claim 15, further comprising:
identifying, by said application specific preprocessor, nodes in the XML file that cannot be processed in a particular processing environment;
replacing content of said nodes with an identifying value; and
storing said content of said nodes to be regenerated after other processing is complete.

21. The computer-readable medium of claim 15, wherein an application specific post-processor is used to modify the processed XML data files so that said processed XML data files can be opened in an original application which was used to create said XML file.

22. The computer-readable medium of claim 21, wherein the application specific post-processor reinserts the processed XML data file into one of an archive file and an Open Office file.

23. The computer-readable medium of claim 11, wherein an application specific postprocessor reinserts the content of said nodes that could not be processing in a particular processing environment into the processed XML data files based on identifiers that were embedded in the XML file by the application specific preprocessor.

24. The computer-readable medium of claim 1, wherein the XML data file contains references to other XML data files that can be retrieved and embedded in said XML data file or can be dynamically generated and embedded in said XML data file.

25. The computer-readable medium of claim 12, wherein the processed XML data file has an envelope structure that is split by a post-processor into multiple separate XML output files each of which is a separate output document.

26. The computer-readable medium of claim of claim 1, further comprising the steps of:
storing said modified XML file;
retrieving said modified XML file; and
merging said modified XML file with XML data to generate a report or data interchange message.

27. A method for modifying an Extensible Markup Language (XML) file comprising:
identifying, within an XML file having at least one data node that contains at least one instruction to modify said XML file, said at least one instruction;
parsing said at least one instruction; and
modifying said XML file in accordance with said at least one instruction to generate a modified XML file.

28. A system for modifying an Extensible Markup Language (XML) file comprising:
a data store for storing an XML file having at least one data node that contains at least one instruction to modify said XML file;
a processor for identifying and parsing said at least one instruction, and then for modifying said XML file in accordance with said at least one instruction to generate a modified XML file.

29. A computer-readable medium which contains instructions which, when read by a processor, performs steps for modifying a source data structure comprising:
identifying, within a source data structure having at least one data node that contains at least one instruction to modify said source data structure, said at least one instruction;
parsing said at least one instruction; and
modifying said source data structure in accordance with said at least one instruction to generate a modified source data structure.
